(19) United States
(12) Patent Application Publication
(10) Pub. No.: US 2014/0321720 A1
(43) Pub. Date: Oct. 30, 2014

(54) MANAGING SOCIAL NETWORK DISTANCE IN SOCIAL NETWORKS USING PHOTOGRAPHS

(71) Applicant: INTERNATIONAL BUSINESS MACHINES CORPORATION, Armonk, NY (US)

(72) Inventors: Judith H. Bank, Cary, NC (US); Liam Harpur, Dublin (IE); Ruthie D. Lyle, Durham, NC (US); Patrick J. O'Sullivan, Dublin (IE); Lin Sun, Morrisville, NC (US)

(73) Assignee: International Business Machines Corporation, Armonk, NY (US)

(21) Appl. No.: 13/873,949

(22) Filed: Apr. 30, 2013

(51) Int. Cl. G06K 9/00

(52) U.S. Cl. CPC G06K 9/00221
USPC 382/118

(57) ABSTRACT

There are provided a method, a system and a computer program product for using a digital image in a social network. The system receives the digital image. The system runs an image processing technique on the digital image. The system determines, based on the run image processing technique, a social distance between the users in the digital image.

### BACKGROUND

This disclosure relates generally to image processing, and particularly to recognizing social distance information embedded in at least one digital image.

### BACKGROUND OF THE INVENTION

Users communicate with each other by using a facial expression, a body expression, an eye gaze, a gesture as well as by using a language. One or more of the facial expression, the body expression, the eye gaze, and the gesture show an emotion of a corresponding user, e.g., six representative emotions—anger, fear, disgust, happiness, sadness, and surprise.

Internet social networking service companies (e.g., Google+® from Google®, Inc. in Mountain view, Calif., Facebook® from Facebook®, Inc. in Menlo Park, Calif., Flickr® from Yahoo® Sunnyvale, Calif. etc.) provide a service of grouping of friends or co-workers. Furthermore, currently, a social distance between users is manually entered by a user, e.g., in an Internet social network.

### SUMMARY

There are provided a method, a system and a computer program product for using a digital image in a social network. The system receives the digital image. The system runs an image processing technique on the digital image. The system identifies, based on the run image processing technique, users in the digital image. The system determines, based on the run image processing technique, a social distance between the users in the digital image.

In order to determine the social distance, the system may receive a plurality of digital images that show the users. The system analyzes, by using the image processing technique, the received digital image and the received plurality of digital images. The analysis includes, but is not limited to: for each digital image, comparing a facial expression or a body expression of a user in the each digital image against facial expressions and body expressions of other users in the each digital image. The system assigns the social distance between the users based on the analysis and the comparison.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 illustrates a flowchart that describes a method for using at least one digital image;

FIG. 2 illustrates a flowchart that describes a methods for identifying of users in one or more digital images;

FIG. 3 illustrates a flowchart that describes a method for determining social distances between users who appear in a plurality of digital images;

FIG. 4 illustrates examples of a computing system that can run the methods illustrated in FIGS. 1-3 and 5-6;

FIG. 5 illustrates a flowchart that describes a method for determining social distances between users in one or more digital image;

FIG. 6 illustrates a flowchart that describes a method for updating a social distance between users;

FIG. 7A illustrate an example calculation of a social distance between two schematic users;

FIG. 7B illustrates another example calculation of a social distance between two schematic users;

FIG. 7C illustrates a digital image that shows two example schematic users;

FIG. 7D illustrates facial images of two example schematic users, which are available in a social network directory or a corporation directory or the both; and

FIG. 8 illustrates an example table that describes example social distances between example users.

### DETAILED DESCRIPTION

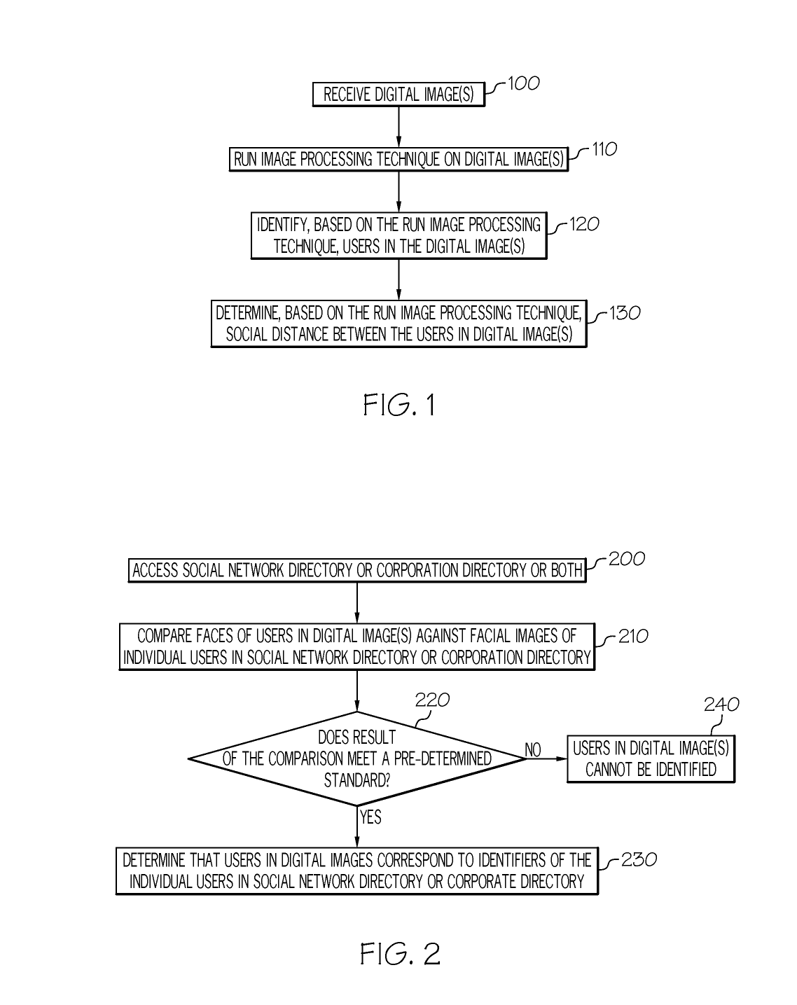

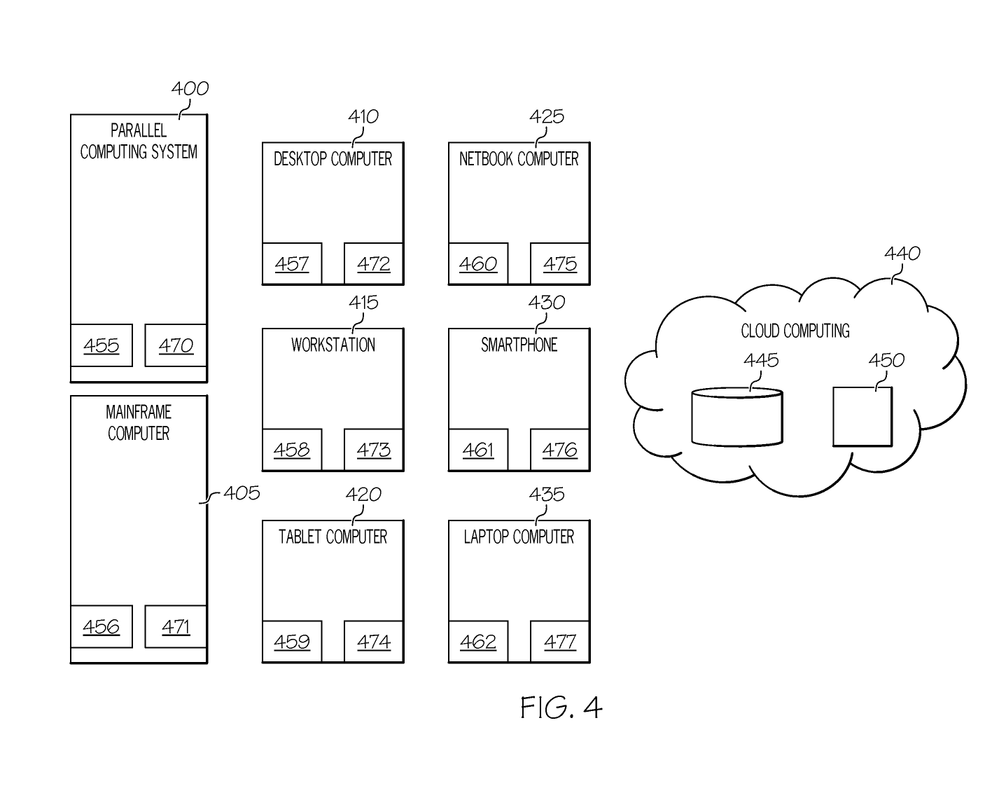

There is provided a method, a system and a computer program product for using at least one digital image in a social network. FIG. 1 illustrates a flowchart that describes a method for using at least one digital image in a social network. FIG. 4 illustrates examples of a computing system that can run the method shown in FIG. 1. These example computing systems may include, but are not limited to: a parallel computing system 400 including at least one processor 455 and at least one memory device 470, a mainframe computer 405 including at least one processor 456 and at least one memory device 471, a desktop computer 410 including at least one processor 457 and at least one memory device 472, a workstation 415 including at least one processor 458 and at least one memory device 473, a tablet computer 420 including at least one processor 456 and at least one memory device 474, a netbook computer 425 including at least one processor 460 and at least one memory device 475, a smartphone 430 including at least one processor 461 and at least one memory device 476, a laptop computer 435 including at least one processor 462 and at least one memory device 477, or a cloud computing system 440 including at least one storage device 445 and at least one server device 450.

Returning to FIG. 1, at 100 in FIG. 1, a computing system receives at least one digital image. The received digital image includes one or more of: a 2-dimensional digital image, a 3-dimensional digital image, a 2-dimensional movie that includes a plurality of 2-dimensional image frames, and a 3-dimensional movie that includes a plurality of 3-dimensional image frames. The digital image may be a mixture of personal or business digital photographs, e.g., a digital photograph depicting a dining out with co-workers. The digital image may be provided from an Internet social network or a database.

At 110 in FIG. 1, the computing system runs an image processing technique on the received digital image. The image processing technique includes one or more of: a face recognition technique, a facial expression recognition technique, a hand or body expression recognition technique, or an eye gaze detection technique. At 120 in FIG. 1, the computing system identifies, based on the run image processing technique, users in the digital image.

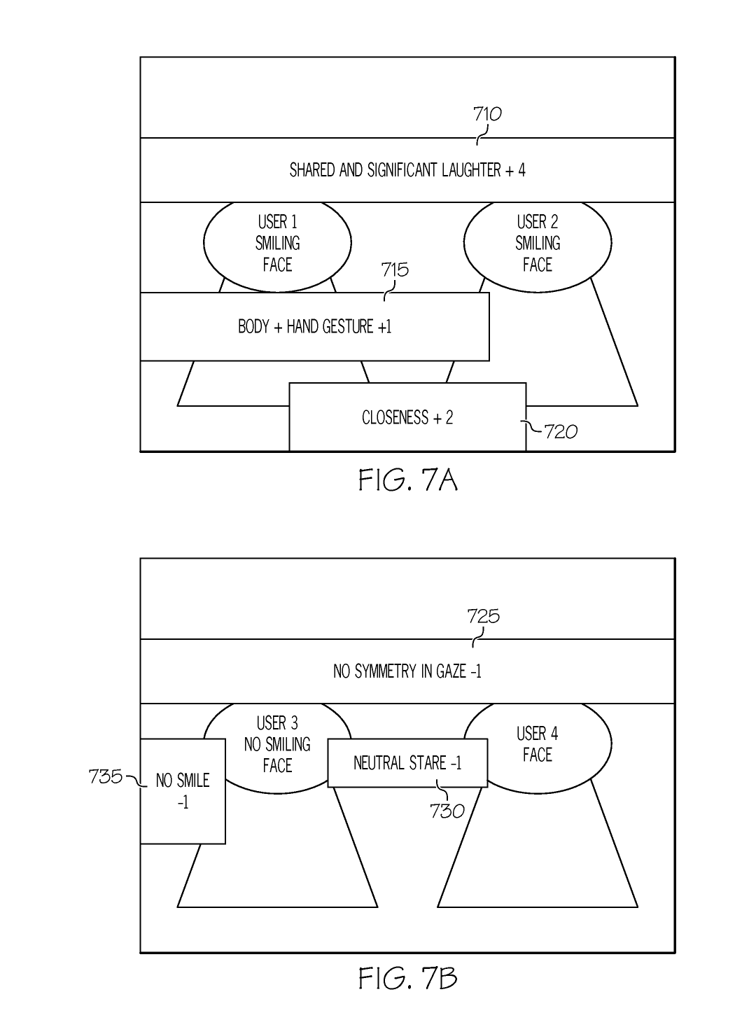

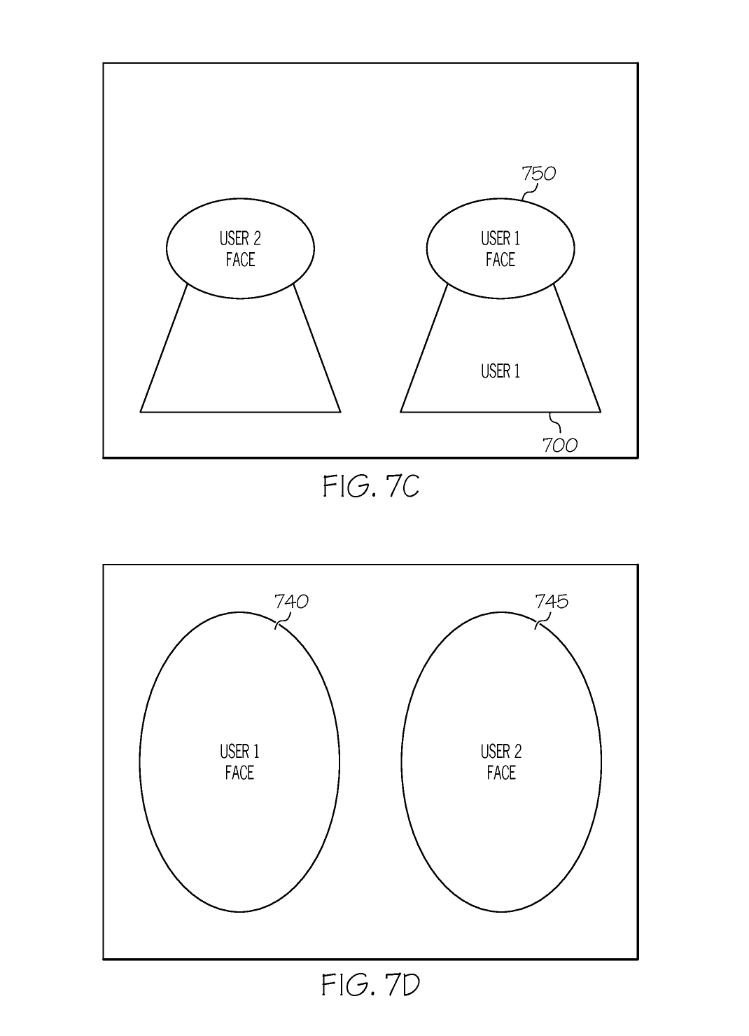

FIG. 2 illustrates a flowchart that describes a method for identifying the users in the received digital image. At 200, the computing system accesses a social network directory or a corporation directory or both, which includes individual users' identifiers (e.g., names, etc.) and corresponding facial images. FIG. 7C illustrates an example received digital image that shows two example users 1 (700) and 2 (705). FIG. 7D illustrates two example facial images 740-745 in a social network directory or a corporate directory or the both. At 210, the computing system runs a facial recognition technique, e.g., FaceSDK® from Luxand®, Inc. in Alexandria, Va., or any other known technique, in order to compare faces of the users in the received digital image against the facial images of the individual users in the accessed social network directory or the corporate directory or the both. For example, the facial recognition technique compares the face 750 of the example user 1 (700) shown in FIG. 7C and the example facial images 740-745 shown in FIG. 7D. At 220, the computing system evaluates whether a result of the comparison meets a pre-determined standard, e.g., more than 95% of facial features of a user in the received digital image match to facial features of an individual user in a social network directory. Facial features may include, but are not limited to: a relative size and position of eyes, lip, nose, etc.

At 230, if a result of the comparison meets the pre-determined standard, the computing system associates one or more corresponding users in the digital image with the identifiers of corresponding individual users in the social network directory or the corporation directory or the both.

If the result of the comparison meets the pre-determined standard, the computing system can also retrieve contact details, e.g., email address(es), phone number(s), fax number(s), etc., of the one or more corresponding users from the social network directory or the corporation directory or the both. The computing system may create a group email address that includes email addresses of the one or more corresponding users.

The computing system may search one or more of: at least one social network directory, at least one corporation directory, at least one email address book, or Internet, with the identifiers (e.g., names, etc.) of the one or more users, which are identified at 230 shown in FIG. 2. The computing system may obtain, from the searched social network directory, the searched email address book, the searched corporate directory or the searched Internet, the corresponding contact details of the one or more users.

Returning to FIG. 2, at 240, if the result of the comparison does not meet the pre-determined standard, the computing system determines that the identifiers of the corresponding users in the digital image cannot be identified.

In one embodiment, when a user selects a first user in the received digital image, e.g., by using an input control device, etc., the computing system may search one or more of: a social network directory, a corporation directory, a directory in a corporation department, a directory in a corporation division, a directory in an organization, a directory in a company, a directory available in Internet, etc., which include identifiers of individual users and their corresponding facial images. While searching these one or more directories, the computing system runs the facial recognition technique in order to compare the facial image of the selected user against facial images in the one or more directories. Upon finding a match between the facial image of the selected user and a facial image of an individual user in a directory, then the computing system determines that the selected user is the individual user whose facial image is matched to the facial image of the selected user. The computing system can further obtain contact details, e.g., email address, phone number, fax number, etc. of the selected user, e.g., from the directory in which the matched individual user is found.

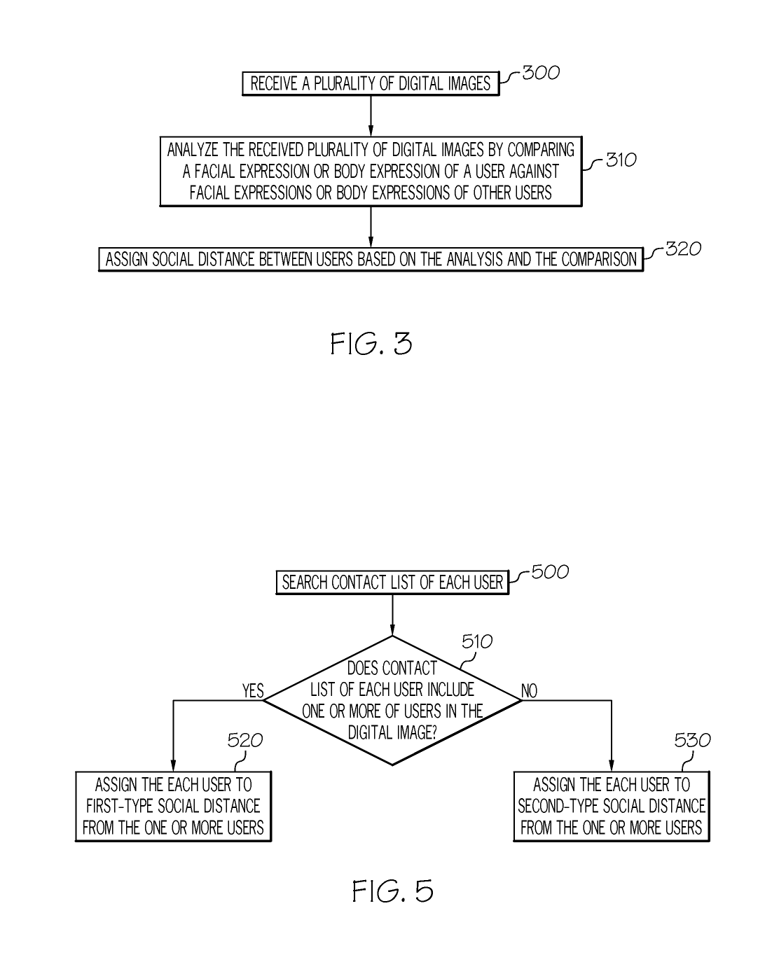

Returning to FIG. 1, at 130, the computing system determines, based on the run image processing technique, a social distance between the users in the received digital image. FIG. 3 illustrates a flowchart that describes a method for determining the social distance between the users in digital images. At 300, the computing system receives a plurality of digital images that show the users. At 310, the computing system analyzes, by using one or more image processing technique, the received plurality of digital images. The computing system runs one or more image processing technique, e.g., FaceReader™, Noldus Information Technology Inc., Leesburg, Va., or any other known technique, in order to detect one or more of: (1) facial expressions of the users in the digital images, (2) a physical distance between the users in the digital images, (3) hand or body expressions of the users in the digital images, (4) at least one direction that the users are looking at in the digital images, or (5) symmetry in facial expressions of the users in the digital images.

In order to detect a facial expression of a user in a digital image, the computing system may perform: (i) identifying facial features, e.g., a mouth and eyes, of the user in the digital image; and (ii) classifying, e.g., by using Neural network, etc., the identified facial features into one of most representative emotions: (a) anger; (b) fear, (c) disgust, (d) happiness, (e) sadness, and (f) surprise.

In order to detect the a hand or body expression of a user in a digital image, the computing system may perform: (i) identifying a body movement or a posture, e.g., a leaning direction, a head position, an arm movement, etc., of the user in the digital image; and (ii) mapping the identified body movement or posture to a specific emotion, e.g., surprise, fear, etc.

In order to detect an eye gaze of a user in a digital image, the computing system may perform one or more of: (i) estimating a center of a pupil of an eye of the user in the digital image; (ii) searching a contour of the pupil of the user in the digital image; (iii) searching a contour of an iris of the user in the digital image; (iv) estimating a radius of an iris of the user in the digital image; or (v) detecting glints from the eye of the user in the digital image.

For each digital image, the computing system compares a facial expression or a body expression of a user in the each digital image against facial expressions and body expressions of other users in the each digital image. The computing system assigns social distance(s) between the users in the digital images based on the analysis and the comparison. For example, if many digital images (e.g., more than 100 digital images) indicate that user 1 and user 2 always laugh at the same time or always have arms around one another, the computing system assigns the user 1 and user 2 to a first-type social distance group, e.g., close friends or co-workers.

In one embodiment, the computing system determines the social distance between the users based on one or more of: a relative body expression, a relative facial expression, a relative eye gaze shown in the digital images. A relative facial or body expression refers to a comparison of a facial or body expression of a user in a digital image against facial or body expressions of other users in the same digital image. A relative eye gaze refers to a comparison of an eye gaze of a user in a digital image against eye gazes of other users in that same digital image. For example, if many digital images may show user 3, user 4, user 5, and user 6 and those many digital images indicate that user 3 and user 4 look at each other and smile but the user 6 and the user 7 look at the user 3 with a frown, then the computing system may assign the user 3 to a first-type social distance (or the first-type social distance group), e.g., close co-workers or friends, from the user 4. On the other hand, the computing system may assign the user 3 a second-type social distance (or a second-type social distance group), e.g., acquaintances, from the users 6-7. In another example, if many digital images may show user 7, user 8, user 9, and other users and those digital images further indicate that user 7 and user 8 are always next to each other but user 9 is always two or three users away from user 7, then the computing system may assign the user 7 and user 8 to the first-type social distance group. The computing system may assign the user 7 to the second-type social distance from the user 9.

Thus, the computing system determines a social network distance based on embedded or derived information, e.g., facial expression, etc., in one or more digital images showing a group of users. For example, by receiving one or more digital images from a user, the computing system can determine who is closest to that user and who is furthest to that user, e.g., by using the method shown in FIG. 3 or FIG. 5. The determined social distance can be used to organize a social network. For example, the computing system may automatically create, e.g., in an Internet social network, one or more social groups of that user, each of which corresponds to a particular social distance, e.g., a first-type social distance—close friends or co-workers. Creating a social group of a user may be similar to creating a web page of the social group in an Internet social network.

In one embodiment, as shown in FIGS. 7A-7B, each body expression, each facial expression and each eye gaze of a user in a digital image may correspond to a particular score associated with a social distance between users in the digital image. For example, laughing at each other 710 may correspond to, for example, a positive score “4.” Having an arm around 715 each other may correspond to, for example, a positive score “1.” A close physical distance 720, e.g., less than a palm length, between the users may correspond to, for example, a positive score “2.” No meeting of eye sights 725 between the users may correspond to, for example, a negative score “−1.” Neutral stare 730 of a user against another user would correspond to, for example, a negative score “−1.” No smile on a face of a user when that user looks at another user would correspond to, for example, a negative score “−1.”

In another embodiment, FIG. 5 illustrates a flowchart that describes another method for determining a social distance(s) between users in at least one digital image. At 500, the computing system searches a contact list of each of the users in the digital image. The contact list of each user in the digital image may be available, e.g., from an Internet social network, a corporate database, etc., from which the identifiers of the users are identified as shown in FIG. 2. At 510, the computing system determines whether the contact list of the each user includes one or more of other users in the digital image. At 520, if the contact list of the each user includes the one or more other users, the computing system assigns the each user to the first-type social distance from the one or more users. At 530, if the contact list of the each user does not include the one or more other users, the computing system assigns the each user to the second-type social distance from the one or more users.

In a further embodiment, a first user shown in a digital image may hover, e.g., by using an input control device, over a second user in that digital image. The computing system determines a social distance between the first user and the second user, e.g., by running the methods shown in FIGS. 1 and 5. The computing system displays the determined social distance to the first user, e.g., via an electronic display device, etc. In the way, the first user can find out a social distance(s) between the first user and other users shown in one or more digital images.

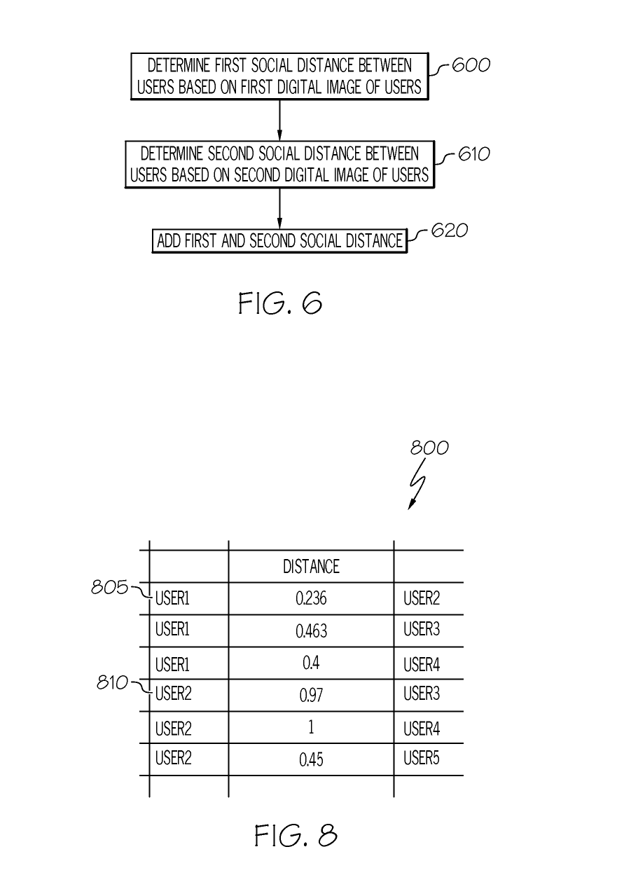

In one embodiment, upon receiving at least one additional digital image that show users, e.g., user 1 and user 2, the computing system updates the social distance between the users based on the received additional digital image. FIG. 6 illustrates a flowchart that describes a method for updating the social distance between the users, e.g., user 1 and user 2. At 600, the computing system determines a first social distance between the users based on a first digital image of the users, e.g., by running the methods shown in FIGS. 1 and 5. At 610, the computing system determines a second social distance between the users based on a second digital image of the users e.g., by running the methods shown in FIGS. 1 and 5. To update the first social distance with the second social distance, at 620, the computing system adds the first and second social distances. The social distance between the users is updated with a result of the addition. For example, if the determined first social distance between the users is, for example, “2” and the determined second social distance between the users is, for example, “−1,” then the updated social distance between the users may become, for example, “1.” In other words, if the determined first social distance is set to a default social distance between the users, after the updating, the determined first social distance becomes, for example, “1.”

Alternatively, the computing system compares the first social distance and the second social distance and determines a new social distance based on the difference between the first social distance and the second social distance. For example, if the difference between the first social distance and the second social distance is less than a threshold, the computing system does not change a current social distance, e.g., the first social distance, between the users. Otherwise, if the difference between the first social distance and the second social distance is equal to or larger than that threshold, an average of the first social distance and the second social distance becomes a new social distance between the users. Alternatively, if the computing system receives at least one digital image from a user 1 and receives at least one digital image from a user 2, the computing system may determine a new social distance between the user 1 and the user 2, e.g., by using an equation: the new social distance between the user 1 and the user 2=Σᵢ₋₁ⁿSᵢ−Σⱼ₌₁^{m}Sⱼ, where i and j are indices, n is the number of digital images received from the user 1, m is the number of digital images received from the user 2, Sᵢ is a social distance calculated from an i^{th} digital image from the user 1, and Sⱼ is a social distance calculated from a j^{th} digital image from the user 2.

In a further embodiment, the computing system determines whether the updated social distance is less than a pre-determined threshold, e.g., 0.8. If the updated social distance is less than the pre-determined threshold, the computing system assigns corresponding users to the first-type social distance group. If the updated social distance is equal to or larger than the pre-determined threshold, the computing system assigns the corresponding users to the second-type social distance group. The updated social distance(s) between users are stored in corresponding social network or corporate database, e.g., in a form of a table, e.g., table 800 shown in FIG. 8. The computing system may run the method shown in FIG. 6 whenever the computing system receives a new digital image showing the corresponding users or whenever a user wants to remove a digital image, e.g., in an Internet social network, which was previously received and stored by the computing system. In one embodiment, the computing system may be a hardware server device that hosts an Internet social network in which users posts a plurality of digital images. Whenever a user of the Internet social network posts or uploads a new digital image, the computing system receives that new digital image and stores the received new digital image, e.g., in a storage device. Whenever a user deletes a digital image posted on the Internet social network, e.g., via the graphical user interface, the computing system deletes that digital image in its storage device.

In a further embodiment, one or more users may set one or more thresholds used to determine a social distance(s) between the users. Alternatively, an Internet social network service provider may set those one or more thresholds. FIG. 8 illustrates an example table 800 that describes example social distances between example users. For example, a social distance 805, e.g., determined by the method shown in FIG. 3 or FIG. 5, between user 1 and user 2 may be, for example, 0.236. A social distance 810 between user 2 and user 3 may be, for example, 0.97. The computing system may assign the user 1 and user 2 to a third-type social distance group, e.g., an extended relationship group or circle, because the social distance 805 between the user 1 and the user 2 is less than a first threshold, e.g., 0.5. The computing system may assign the user 2 and the user 3 to the first-type social distance group because the social distance 810 between the user 2 and the user 3 is larger than a second threshold, e.g., 0.8.

In one embodiment, a user may create an email message, e.g., by using the computing system. The computing system analyzes a content of the email message, for example, by using a content analysis tool (e.g., Yoshikoder developed from Havard's Weatherhead Center for International Affairs, Cambridge, Mass., or any other known technique or tool). The computing system suggests, based on the analyzed content of the email message, at least one email recipient, who may be shown in one or more digital images processed according to the method(s) in FIG. 1 or FIG. 3 or FIG. 5. The one or more processed digital images may also show the user who created the email message. For example, if the computing system determines that user 1 and user 2 belong to the first-type social group, and a user 1 creates an email message, which includes a joke message and whose email recipient(s) does not include the user 2, then the computing system may suggest that that email message is also sent to the user 2 as wells as one or more email recipients who are manually entered by the user 1. The computing system may provide a graphical user interface that enables a user, e.g., the user 1, to select one or more email recipients among the suggested email recipients. The computing system sends the email message to the selected email recipients as well as email recipient(s) whose email addresses are manually entered by the user who created the email message.

In one embodiment, after determining the identifiers of users in a digital image, e.g., by running the method shown in FIG. 2, the computing system can also obtain contact details of the users, e.g., from a corresponding social network directory or a corresponding corporation directory or Internet, etc. However, if contact detail(s) of one or more users in the digital image is ambiguous, the computing system updates the contact detail(s) of the one or more users in the digital image according to a rule. Contact detail of a first user is ambiguous if: (A) the computing system cannot obtain the contact detail of that first user, e.g., from a corresponding social network directory or a corporation directory from which the identifier of that user is found; or (B) one or more users provide different contact details associated with the first user.

In a further embodiment, a user may create the rule to update contact detail(s) of the one or more user in the digital image. In another embodiment, the computing system creates the rule, e.g., by employing a data mining technique. For example, by using Association rule learning technique, the computing system may be able to discover, e.g., from a database that stores records associated with prior ambiguous contact details of users, one or more rules associated with updating contact details, e.g., if information comes from user 1 and user 2, that information is always correct; so, whenever ambiguity arises regarding an email address of other user, use information from the user 1 and the user 2.

The created rule may specify to: (1) assign a different weight to each of the users in the digital image; and (2) determine contact details of the one or more users according to information provided from a user who has a highest weight. Alternatively, the created rule may specify to: (1) receive, from one or more of the users in the digital image, the contact detail(s) of at least one user in the digital image whose contact detail is ambiguous; and (2) replace the ambiguous contact detail(s) of the user with contact detail(s) that a majority of users in the digital image provide.

In one embodiment, the computing system may receive a plurality of digital images, e.g., from an Internet social network, and store the received plural digital images in a storage device. Each received digital image may show one or more users. The computing system may provide a graphical user interface that enables a user to select one digital image among the digital images stored in the storage device. When the computing system detects a selection of one digital image by that user, the computing system displays (e.g., pops up) a new email message whose email recipients are users shown in the selected digital image. As described above, the email addresses of those email recipients would be obtained, e.g., from an Internet social network directory or a corporation directory, etc. In one embodiment, when the computing system detects a selection of one digital image by that user, the computing system creates a social group in an Internet social network whose members include the users in the selected digital image. For example, the computing system may create a web page, e.g., in an Internet social network, of a social group whose members include the users in the selected digital image. The created web page may display the selected digital image.

In another embodiment, the methods shown in FIGS. 1-3, 5-6 and 8 may be implemented as hardware on a reconfigurable hardware, e.g., FPGA (Field Programmable Gate Array) or CPLD (Complex Programmable Logic Device), by using a hardware description language (Verilog, VHDL, Handel-C, or System C). In another embodiment, the methods shown in FIGS. 1-3, 5-6 and 8 may be implemented on a semiconductor chip, e.g., ASIC (Application-Specific Integrated Circuit), by using a semi custom design methodology, i.e., designing a semiconductor chip using standard cells and a hardware description language.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for using a digital image in a social network, the method comprising:
receiving the digital image;
running an image processing technique on the digital image;
identifying, based on the run image processing technique, users in the digital image; and
determining, based on the run image processing technique, a social distance between the users in the digital image,
wherein a processor coupled to a memory device performs the receiving, the running, the identifying, and the determining.

2. The method according to claim 1, wherein the digital image includes one or more of:
a 2-dimensional digital image;
a 3-dimensional digital image;
a 2-dimensional movie that includes a plurality of 2-dimensional image frames; and
a 3-dimensional movie that includes a plurality of 3-dimensional image frames.

3. The method according to claim 1, wherein the digital image is obtained from the social network or a database.

4. The method according to claim 1, wherein the identifying the users in the digital image comprises:
accessing a social network directory or a corporation directory or both, which includes individual users' identifiers and corresponding facial images;
comparing faces of the users in the digital image against the facial images of the individual users in the accessed social network directory or the corporate directory or the both; and
in response to that a result of the comparing meets a pre-determined standard, determining that the users in the digital image correspond to the identifiers of the individual users in the social network directory or the corporate directory or the both.

5. The method according to claim 1, wherein the image processing technique includes one or more of:
a face recognition technique;
a facial expression recognition technique;
a hand or body expression recognition technique; or
an eye gaze detection technique.

6. The method according to claim 1, wherein the determining the social distance comprises one or more of:
recognizing facial expressions of the users in the digital image;
recognizing a physical distance between the users in the digital image;
recognizing a hand or body expression of the users in the digital image; or
detecting at least one direction that the users are looking at in the digital image.

7. The method according to claim 1, wherein the determining the social distance comprises:
additionally receiving a plurality of digital images that show the users;
analyzing, by using the image processing technique, the received digital image and the received plurality of digital images, the analyzing including: for each digital image, comparing a facial expression or a body expression of a user against facial expressions and body expressions of other users; and
assigning the social distance between the users based on the analyzing and the comparing.

8. The method according to claim 1, wherein the determining the social distance comprises:
searching a contact list of each of the users;
determining whether the contact list of the each user includes one or more of the users in the digital image;
in response to determining that the contact list of the each user includes the one or more users, assigning the each user to a first-type social distance from the one or more users; and
in response to determining that the contact list of the each user does not include the one or more users, assigning the each user to a second-type social distance from the one or more users.

9. The method according to claim 1, further comprising:
receiving an additional digital image that displays one or more of the users; and
updating the social distance between the users based on the received additional digital image.

10. The method according to claim 9, wherein the updating the social distance between the users comprises:
determining a first social distance between the users based on a first digital image of the users;
determining a second social distance between the users based on a second digital image of the users; and
adding the first and second social distances,
wherein the social distance between the users is updated with a result of the adding.

11. The method according to claim 9, further comprising:
determining whether the updated social distance is less than a pre-determined threshold;
in response to determining that the updated social distance is less than the pre-determined threshold, assigning the users to a first-type group; and
in response to determining that the updated social distance is equal to or larger than the pre-determined threshold, assigning the users to a second-type group.

12. The method according to claim 1, further comprising:
receiving, from one of the users, an email message;
analyzing a content of the email message; and
suggesting, based on the analyzed content of the email message, an email recipient among the users.

13. The method according to claim 1, further comprising:
automatically creating a social group in the social network that includes the users in the digital image.

14. The method according to claim 1, further comprising:
detecting that an input control device is hovered over a user in the digital image; and
displaying the determined social distance from the user.

15. A system for using a digital image in a social network, the system comprising:
at least one memory device;
a processor coupled to the memory device,
wherein the processor is configured to perform:
receiving the digital image;
running an image processing technique on the digital image;
identifying, based on the run image processing technique, users in the digital image; and
determining, based on the run image processing technique, a social distance between the users in the digital image.

16. The system according to claim 15, wherein the image processing technique includes one or more of:
a face recognition technique;
a facial expression recognition technique;
a hand or body expression recognition technique; or
an eye gaze detection technique.

17. The system according to claim 16, wherein in order to determine the social distance, the processor is further configured to perform:
additionally receiving a plurality of digital images that show the users;
analyzing, by using the image processing technique, the received digital image and the received plurality of digital images, the analyzing including: for each digital image, comparing a facial expression or a body expression of a user against facial expressions and body expressions of other users; and
assigning the social distance between the users based on the analyzing and the comparing.

18. The system according to claim 15, wherein in order to determine the social distance, the processor is further configured to perform:
searching a contact list of each of the users;
determining whether the contact list of the each user includes one or more of the users in the digital image;
in response to determining that the contact list of the each user includes the one or more users, assigning the each user to a first-type social distance from the one or more users; and
in response to determining that the contact list of the each user does not include the one or more users, assigning the each user to a second-type social distance from the one or more users.

19. A computer program product for using a digital image in a social network, the computer program product comprising a storage medium that excludes a propagating signal, the storage medium readable by a processing circuit and storing instructions run by the processing circuit for performing a method, said method steps comprising:
receiving the digital image;
running an image processing technique on the digital image;
identifying, based on the run image processing technique, users in the digital image; and
determining, based on the run image processing technique, a social distance between the users in the digital image.

20. The computer program product according to claim 19, wherein the determining the social distance comprises:
additionally receiving a plurality of digital images that show the users;
analyzing, by using the image processing technique, the received digital image and the received plurality of digital images, the analyzing including: for each digital image, comparing a facial expression or a body expression of a user against facial expressions and body expressions of other users; and
assigning the social distance between the users based on the analyzing and the comparing.
